(19) United States
(12) Patent Application Publication
(10) Pub. No.: US 2006/0023065 A1
(43) Pub. Date: Feb. 2, 2006

(54) Multiple program and 3D display with high resolution display and recording applications

(76) Inventor: Ray M. Alden, Raleigh, NC (US)

Correspondence Address: Ray M. Alden, 808 Lake Brandon Trail, Raleigh, NC, 27610, US

(21) Appl. No.: 10/903,443

(22) Filed: Jul. 31, 2004

(51) Int. Cl. H04N 13/04; H04N 9/12

(52) U.S. Cl. 348/51; 348/383

(57) ABSTRACT

In a first preferred embodiment, this invention provides a low cost means for multiplying the resolution of a display. In an iterative process, a DLP projects a first image which is directed to a first quadrant of a display screen, a second image which is directed to a second quadrant of the display screen, a third image which is directed to a third quadrant of the display screen, and a fourth image which is directed to a fourth quadrant of the display screen. Each of the four images comprising a quarter of a full high resolution image which are by this process tiled together to comprise one high resolution image. In a second embodiment, image pixels are steered at the pixel level to comprise a display that can alternately produce a wide range of resolutions on a PDLC in a translucent state or alternately operate as an auto stereoscopic 3D display or alternately operate as a multiple program display enabling multiple users to watch different full resolution programs on the same display concurrently. The 3D and multiple program images being passed through the PDLC caused to be in a transparent state.

### CROSS-REFERENCE TO RELATED APPLICATIONS

One or more pixel collimation and image steering methods relied upon herein were also described in one or more of the following patent applications or provisional patent applications by the present applicant; No. 60/473,865 filed May 29, 2003, Ser. No. 10/455,578 filed Jun. 5, 2003, Ser. No. 10/464,272 filed Jun. 18, 2003, No. 60/483,557 foiled Jun. 27, 2003 No. 60/485,588 filed Jul. 7, 2003, No. 60/485,863 filed Jul. 9, 2003, No. 60/488,305 filed Jul. 16, 2003 No. 60/515,528 filed Oct. 29, 2003, No. 60/517,546 filed Nov. 5, 2003, the patent application filed Jul. 3, 2004 titled “Process and apparatus for efficient multiple program and 3D display” of unknown number, and the PCT application 04/16,563 filed May 27, 2004.

### BACKGROUND FIELD OF INVENTION

Modern video monitors incorporate many technologies and methods for providing high quality video to users. Nearly every household in the United States has one or more video monitors in the form of a television or a computer monitor. These devices generally use technologies such as Cathode Ray Tubes (CRT) tubes, FEDs, Liquid Crystal Displays (LCD), OLEDs, Plasma, Lasers, LCoS, Digital Micromirror Devices (DMD), front projection, rear projection, or direct view in one way or another. Large monitors offer the advantage of enabling many users to see the video monitor simultaneously as in a living room television application for example. Often video users do not want to view the same image streams as one another. Instead viewers would often like to see completely different programs or image streams at the same time. Alternately viewers would like to see the same program in 3D (three-dimensional) format. Moreover, people would like to enjoy high resolution images on their video monitors.

The prior art describes some attempts to enable multiple viewers to see different image streams concurrently on the same monitor. Many are drawn to wearing glasses that use polarization or light shutters to filter out the unwanted video stream while enabling the desired video stream to pass to the users' eyes. Much prior art that enables multiple users to watch different programs concurrently on the same display, full screen size and full resolution has been described by the present applicant in prior patent disclosure referenced below. The prior art also describes displays which use time sequenced spatial multiplexing as a means to enable multiple viewers to view auto stereoscopic 3D images on the same screen concurrently with the unaided eye. The prior art also describes a method for achieving high resolution images announced by Hewlett Packard where a lower resolution image generator such as a DLP produces a plurality of images representative of a single image frame and an element is actuated in physical distances on the order of a pixel in magnitude in synchronization with the image generator to produce alternate pixels on a diffuse surface. Moreover, no practicable display adequately incorporates multiple program viewing with auto-stereoscopic 3D to be viewed from the same Television pixels at the virtually the same time by multiple viewers together with the means to multiply the resolution of the image as does the present invention.

The present invention provides a significant step forward for video monitors. The present invention describes display architectures that can be used with many display technologies together with specific implementations including a high resolution image recording and image displaying technique each employing a rotating optical element for beam steering. A second embodiment for creating high resolution displays employs a screen surface that can transition between translucent and transparent states such that the pixel steering method can be used alternately for generating high resolution images or for enabling multiple viewers to watch different programs concurrently and for watching auto stereoscopic 3D video. The art described herein is suitable for enhancing the performance of many image generators including Cathode Ray Tubes (CRT) tubes, FEDs, Liquid Crystal Displays (LCD), OLEDs, Plasma, Lasers, LCoS, and Digital Micromirror Devices (DMD), and in front projection, rear projection, or direct view applications.

### BACKGROUND-DESCRIPTION OF PRIOR INVENTION

The prior art describes some attempts to enable multiple viewers to see different video streams concurrently on the same monitor. Many are generally drawn to wearing glasses that use polarization or light shutters to filter out the unwanted video stream while enabling the desired video stream to pass to the users' eyes. U.S. Pat. No. 6,188,442 Narayanaswami being one such patent wherein the users wear special glasses to see their respective video streams. U.S. Pat. No. 2,832,821 DuMont does provide a device that enables two viewers to see multiple polarized images from the same polarizing optic concurrently. DuMont however also requires that the viewers use separate polarizing screens as portable viewing aids similar to the glasses. DuMont further requires the expense of using two monitors concurrently. No known prior art provides a technique to enable multiple viewers to view separate video streams and watch auto stereoscopic 3D programs on a display which is also adapted to provide increased resolution over the capability of the image generator.

The so called “Cambridge Display” or “Travis Display” provides a well publicized means for using time sequential spatially multiplexed viewing zones as a method to enable multiple viewers to see auto-stereoscopic 3-D images on a display. This technique is described in U.S. Pat. No. 5,132,839 Travis 1992, U.S. Pat. No. 6,115,059 Son et al 2000, and U.S. Pat. No. 6,533,420 Eichenlaub 2003. The technique is also described in other documents including; “A time sequenced multi-projector auto-stereoscopic display”, Dodgson et al, Journal of the Society for Information Display 8(2), 2000, pp 169-176; “A 50 inch time-multiplexed auto-stereoscopic display” Proceedings SPIE Vol 3957, 24-26 Jan. 2000, San Jose Calif., Dodgson, N. A., et al.; Proceedings SPIE Vol 2653, Jan. 28-Feb. 2, 1996, San Jose, Calif., Moore, J. R., et al.; and can be viewed at http://www.cl.cam.ac.uk/Research/Rainbow/projects/asd.html. This prior art typically relies on optics to first compress the entire image from a pixel generator such as a CRT tube, secondly an optical element such as a shutter operates as a moving aperture that selects which orientation of the entire compressed image can pass therethrough, thirdly, additional optics magnify the entire image, and fourthly the image is presented to a portion of viewer space. This process is repeated at a rate of approximately 60 hertz with the shutter mechanism operating in sync with the pixel generator to present different 3D views to different respective portions of viewer space. Two main disadvantages of this prior art are easily observable when viewing their prototypes. A first disadvantage is that a large distance on the order of feet is required between the first set of optics and the steering means, and between the steering means and the second set of optics. This disadvantage results in a display that is far too bulky for consumer markets or for any flat panel display embodiments. Secondly, looking at the display through large distances between optics creates a tunnel effect that tends to diminish the apparent viewable surface area of the resultant viewing screen.

According to Deep Light of Hollywood, Calif., the intellectual property comprising the “Cambridge display” is owned and being advanced by Deep Light. Also Physical Optics Corporation describes on their website that they are currently building a prototype of a time sequenced 3D display using liquid crystal beam steering at the pixel level similarly to that which has been described by the present applicant in the related applications referenced in this document.

Also Hewlett Packard has announced a “wobleation” process that physically moves a DLP image generator having a first resolution through a tiny position cycle in sync with driving it to produce every alternate pixel at a faster generation rate with the result being a higher second resolution image being projected on a diffuse surface. Increasing resolution using this methodology requires optics to manipulate the image at the sub pixel level or alternately, larger distances between pixel at the chip level, thus the actuation of the DLP chip approach to increasing resolution is not easily upgradeable without substantial cost to a user. Also, the method developed by HP requires a predefinition of what the maximum resolution of the display will be. Whereas the present invention discloses a means to change the resolution of the display on the fly as a function of the resolution of the image being displayed.

By contrast the present invention describes a first embodiment which provides a rotating optical element as the means to steer images from a DLP and tile a plurality of them together to produce higher resolution images than what the DLP is otherwise capable of. This demonstrates multiplying the DLP's image rsolution resolution by steering images at the sub image level instead of at the sub-pixel level as reportedly done by Hewlett Packard. The DLP produces quadrants of a high resolution in succession which are directed by a rotating optic to respective quadrants of a diffuse translucent (rear projection) or diffuse opaque (front projection) screen. This art is also demonstrated operating in reverse to record scenes with resolution multiplesof what a CCD is capable of.

In a second and third embodiment, the present invention provides steering of images at the sub-pixel level as part of a display for enabling multiple users to watch multiple 2-D or 3-D programs on the same display at the same time, full screen and full resolution. This same display includes an PDLC optical element that can transition from transparent to translucent. When in the translucent state, the beam steering technique is used to provide increased resolution viewing that conforms with the resolution of the image file on the fly. Using the disclosed steering methods, in real-time, the display can easily switch between displaying normal resolution, high resolution, and a range of many other resolutions depending upon the resolution of the images that are to be displayed. Also when the PDLC is in the transparent state, the pixel level beam steering is used to enable multiple user to watch different programs on the same display at the same time full screen and full resolution. Also when the PDLC is in the transparent state, the display produces auto stereoscopic 3-D video viewable by many concurrent users with the unaided eye.

Other relevant disclosures have been made by the present applicant including; patent application Ser. No. 10/455,578, and several patent applications referenced therein each being incorporated herein by reference.

### BRIEF SUMMARY

The invention described herein represents a significant improvement for the users of displays. In a first embodiment, resolution of an image generator such as a DLP is increased using a rotating optical element in sync with the DLP successively producing quadrants of a high resolution image which are steered to quadrants of a displayed high resolution image on a diffuse translucent or opaque surface.

In a second and third embodiment, pixel steering at the sub image level which was disclosed by the present applicant in prior patent applications referenced above and incorporated herein by reference is used to provide a high resolution display on a PDLC surface in a translucent state and alternately to provide a multiple program and auto stereoscopic 3-D display through the PDLC surface which is transformed to be in a transparent state.

Thus the present invention offers a significant advancement in both the resolution and functionality of video monitors or displays.

Objects and Advantages

Accordingly, several objects and advantages of the present invention are apparent. It is an object of the present invention to provide an image display means which enables multiple viewers to experience completely different video streams simultaneously. This enables families to spend more time together while simultaneously independently experiencing different visual media or while working on different projects in the presence of one another or alternately to concurrently experience auto stereoscopic 3D media with their unaided eyes. Also, electrical energy can be saved by concentrating visible light energy from a display into narrower user space where a user is positioned. Likewise when multiple users use the same display instead of going into a different room, less electric lighting is required. Also, by enabling one display to operate as multiple displays, living space can be conserved which would otherwise be cluttered with a multitude of displays.

It is an advantage that the present invention doesn't require special eyewear, eyeglasses, goggles, or portable viewing devices as does the prior art.

It is an advantage of the present invention that the same monitor that presents multiple positionally segmented image streams also can provide true positionally segmented auto stereoscopic 3D images as well as stereoscopic images.

It is an advantage of the present invention that resolution is not sacrificed in order to achieve 3D images and neither is resolution sacrificed to present multiple concurrent positionally segmented image streams and neither is resolution sacrificed to present stereoscopic image streams.

It is an advantage of the first embodiment that resolution of the underlying image generator can be multiplied by tiling of multiple image segments together to form a complete image as opposed to providing alternate pixels.

It is an advantage of the first embodiment that the identical techniques can be employed for recording high resolution images.

It is an object of the second embodiment to provide a display that can increase resolution by a nearly unlimited amount on the fly while also provide a 3-D auto stereoscopic capability combined with the capability to display multiple programs viewable by respective multiple viewers in respective viewing positions, each viewer seeing full resolution and full screen size video concurrently on a single display.

Further objects and advantages will become apparent from the enclosed figures and specifications.

### DRAWING FIGURES

FIG. 1 illustrates a rotating quadrant directing optic used for multiplying the DLP's resolution.

FIG. 2 depicts a high resolution projection system projecting the pixels of a DLP onto a first quadrant of a diffuse screen.

FIG. 3 depicts the projection system of FIG. 2 projecting the pixels of a DLP onto a second quadrant of a diffuse screen.

FIG. 4 depicts the projection system of FIG. 2 projecting the pixels of a DLP onto a third quadrant of a diffuse screen.

FIG. 5 depicts the projection system of FIG. 2 projecting the pixels of a DLP onto a fourth quadrant of a diffuse screen.

FIG. 6 depicts the projection system of FIG. 2 projecting the pixels of a DLP onto the entire surface of a diffuse screen.

FIG. 7 depicts the high resolution video recording process using a rotating optic to multiply the resolution of a CCD.

FIG. 8 illustrates the process for recording and projecting high resolution images of the first embodiment of the present invention.

FIG. 9a illustrates a first pixel collimating architecture.

FIG. 9a illustrates a second pixel collimating architecture.

FIG. 10a discloses a collimated pixel LC steering method of producing multiple program and auto stereoscopic viewing zones in a first steering state.

FIG. 10b discloses a collimated pixel LC steering method of producing multiple program and auto stereoscopic viewing zones in a second steering state.

FIG. 11a depicts the art of FIG. 10a used for creating a first high resolution pixel.

FIG. 11b depicts the art of FIG. 10b used for creating a second high resolution pixel.

FIG. 12a depicts the high resolution pixel generation of 11a with an actuation steering method replacing the LC steering method generating a first high resolution pixel.

FIG. 12b depicts the art of FIG. 12a generating a second high resolution pixel.

FIG. 13a depicts the art of FIG. 12a creating a pixel directed to a first viewing zone.

FIG. 13b depicts the art of FIG. 12b creating a pixel directed to a second viewing zone.

FIG. 14 depicts an array of pixel level optics similar to the individual optics depicted in FIG. 12a.

FIG. 15 illustrates the resolution enhancement of a low resolution CRT compared to the high resolution pixels created by steering the CRT pixels.

### DETAILED DESCRIPTION OF THE INVENTION

### First Embodiment—Preferred

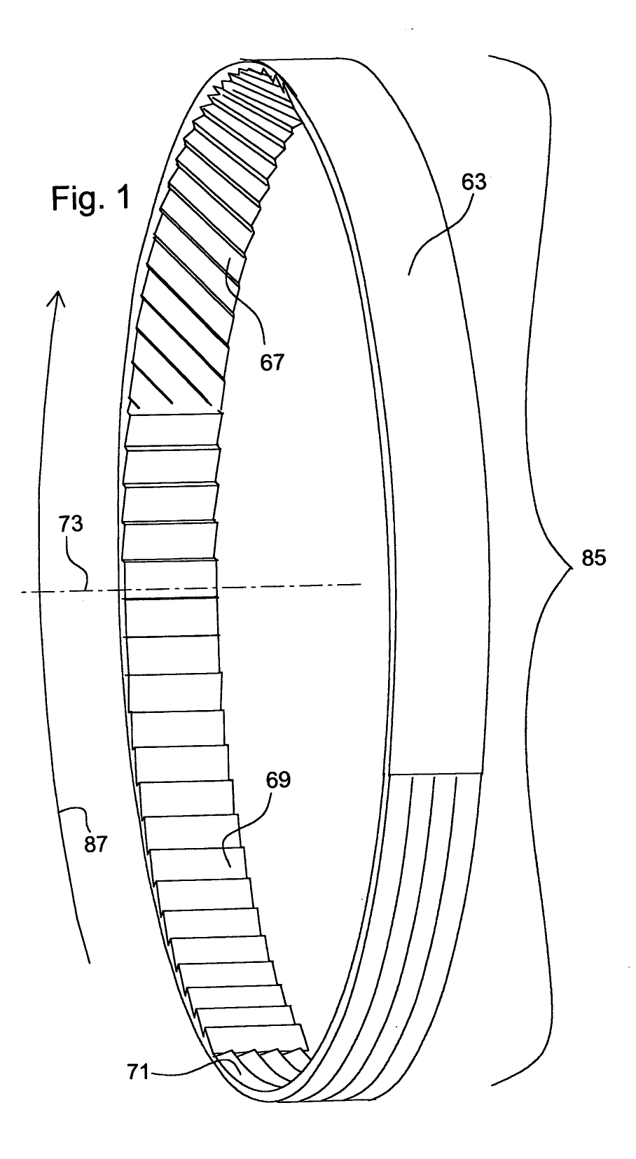

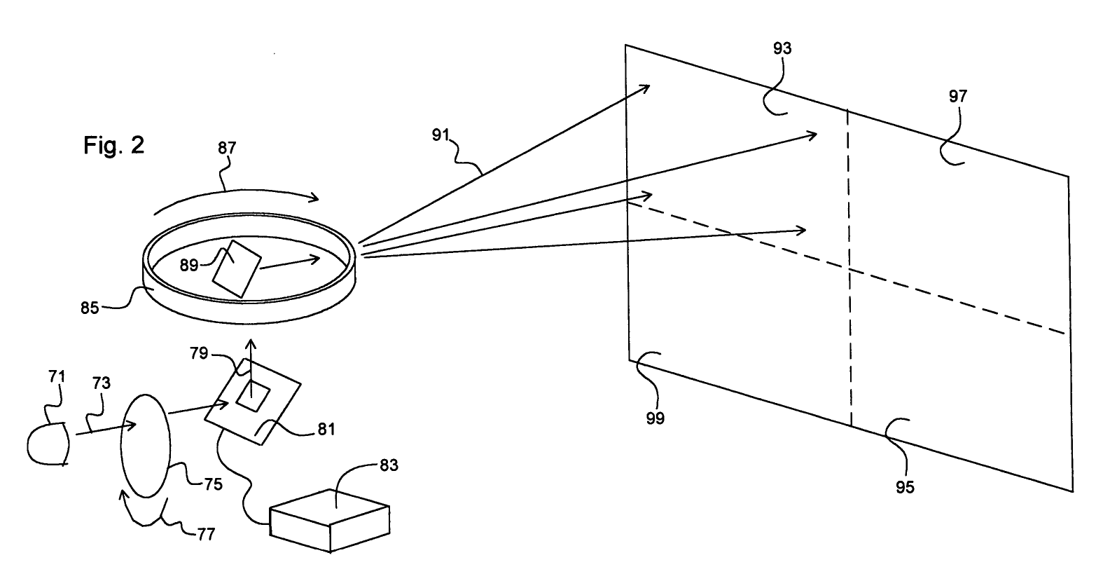

FIG. 1 illustrates a rotating quadrant directing optic used for multiplying the DLP's resolution. A rotating resolution multiplier optic 85 rotates about a first rotational axis 73. The 85 comprises four optical segments which when positioned horizontally (as seen in FIG. 2), include a flat refractive optical segment 63 further described in FIG. 2, a forty five degree refractive optical segment 67, a horizontal refractive optical element 69, and a vertical optical element 71. Each optical segment is manufactured to act as a Fresnel prism having a plurality of flat segments on the inner surface matched with flat segments on the outer surface to enable beam steering through each Fresnel optical structure while not the structures. A rotation 87 around 73 presents respective optical segments of the 85 to a projected image stream as described in FIG. 2 such that 85 modulates the direction of the image stream as described in FIGS. 2 through 5. Each optical segment 63, 67, 69, and 71 are manufactured as transparent Fresnel structures which are then glued within a transparent ring to together become a solid optical rigid structure comprising the 85.

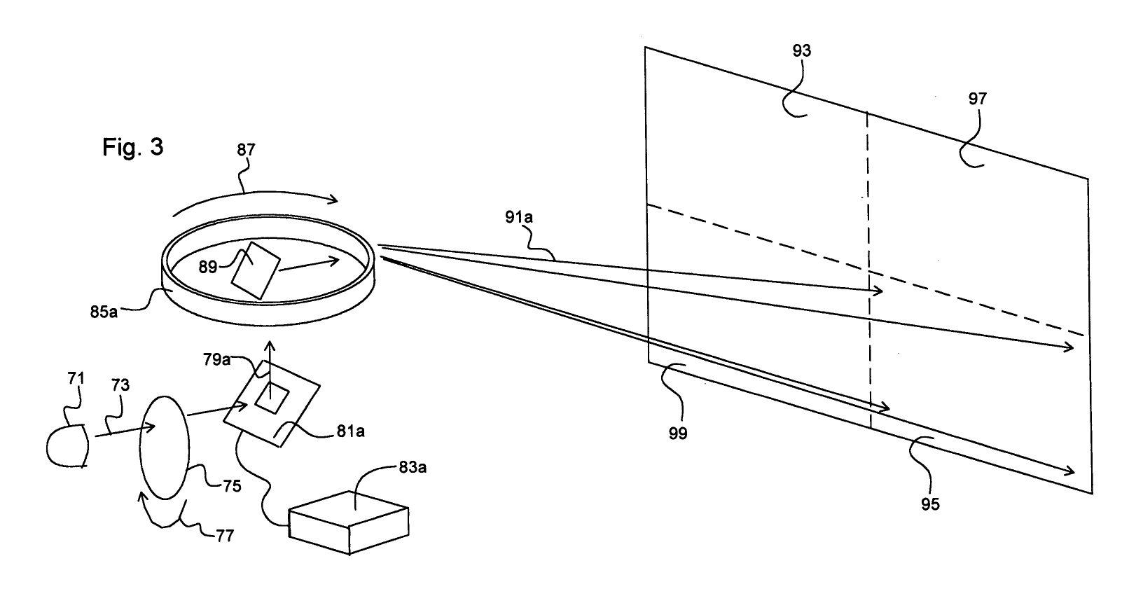

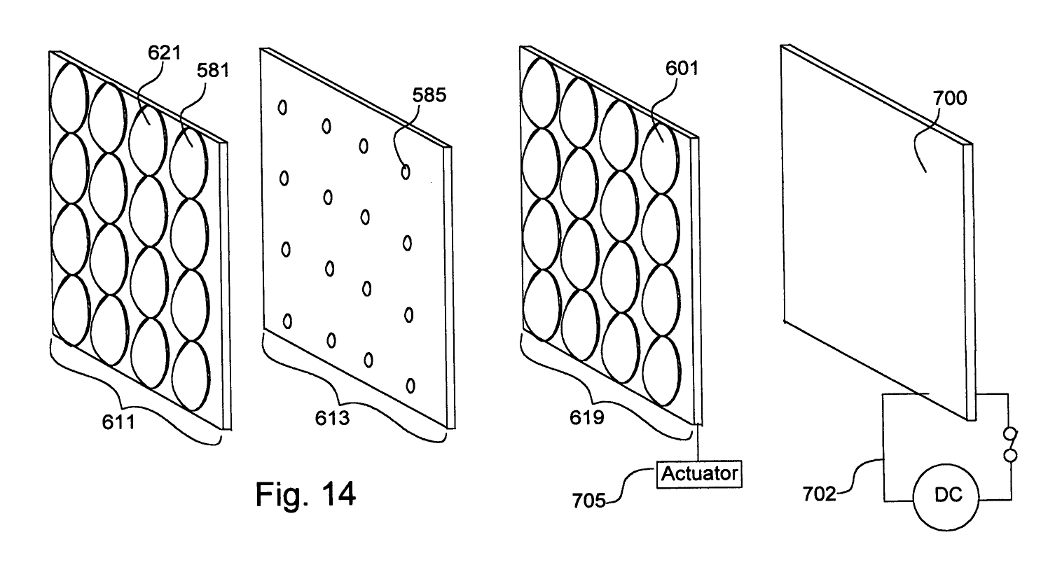

FIG. 2 depicts a high resolution projection system projecting the pixels of a DLP onto a first quadrant of a diffuse screen. A collimated light source 71 produces a white light stream 73 which passes though a rotating color wheel 75 which has a rotating motion 77 such that light incident upon a DLP on a card 81 is alternately red, green and blue. The 81 is controlled by a image processor 83 which comprises a memory including a high resolution image and an image processor for tiling the high resolution image into four parts to be present to the DLP as four separate images. The DLP card and chipset 81 are capable of producing a 1024×768 pixel resolution which when multiplied by four using the art described in FIGS. 1 through 5 results in a resolution of 2048×1536 pixel resolution. The image to be displayed has the higher resolution and is displayed at full resolution using four image iterations of the DLP which has the lower resolution. FIG. 2 describes the first iteration where the red, green, and blue portions of a quarter of the high resolution image are reflected by the DLP 81 as reflected image stream 79 which in turn is reflected by a shaping mirror 89 before passing through the rotating steering optic 85. The 89 causes the light to become divergent. At the instance depicted in FIG. 2, the 79 image is modulated through the 63 portion of 85 as described in FIG. 1. The 63 consists of a series of flat parallel surfaces such that the trajectory of the light produced by 89 is maintained as it becomes a projected quarter image 91 which is incident upon diffuse screen first quarter 93. The image incident on the 93 portion of the screen is 1024×768 pixels representing one quarter of the full image in the memory of the 83 and it is the first tile of four to be displayed. The timing of the rotation of the color wheel 75, the DLP 81, and the processor 83 are controlled by the processor to be kept in sync such that sub-image colors, image quarters, and directing optics cooperatively produce a high resolution projected image stream within the 93 portion of the diffuse screen and the other portions including a second screen quarter 95 which will receive the second tile of the image, a third screen quarter 97 which will receive the third tile of the image, and a fourth screen quarter 99 which will receive the fourth tile of the high resolution image. Projection of tiles the second, third, and fourth tiles is discussed in FIGS. 3 through 5. The process of driving the DLP at four times its standard rate of operation has been amply demonstrated in the prior art including descriptions by the present applicant. The diffuse screen including 93, 95, 97, and 99 can be opaque such as with a front projection application, or translucent such as with a rear projection application. Additionally, as discussed in FIG. 14 (elements 700 and 702 cooperatively) the diffuse screen can also comprise a PDLC which with a change in response of the application of an electric field can transition to a transparent for enabling this high resolution display architecture to be used to project auto-stereoscopic 3D image streams and/or multiple spatially segmented programs such that different viewers can concurrently watch different content from the same display at the same time, full screen, and full resolution. It will be further understood that if for example a 1024×768 pixel resolution image is to be displayed, it can still be done utilizing the 85 to tile four images onto the diffuse screen but to achieve this, every one pixel in the image file will be displayed on four DLP pixels in a quarter image. This demonstrates that the higher the number of directing optical segments in the 85 type optic, the wider the range of resolutions that the system can produce. For example since the 85 has four optical segments, it can produce four times the resolution of the DLP and a range of lesser resolutions as well. Alternately, a stack of elements similar to the 85 can be added to concurrently rotate around the 73 and be changed on the fly to accommodate content of higher or lower resolution as well as auto-stereoscopic 3D applications and multiple program viewing applications. For example, if the content is eight times as resolute as the DLP, a different rotating optical steering element can be lower into the plane of the 89 so as to direct the image in a given instant into smaller tiled sections of the diffuse screen.

FIG. 3 depicts the projection system of FIG. 2 projecting the pixels of a DLP onto a second quadrant of a diffuse screen. In a subsequent time and due to the 87 rotation, a rotating directing optic in first successive orientation 85a is now in position to direct light to the second quadrant of the diffuse screen 95 producing the second tile of a four tile image. A first successive processor 83a presents the second quarter of the high resolution image from memory to a successive DLP chip set 81a which in turn produces red, green, and blue portions of a first successive image 79a which are reflected off of the 89 before being incident upon the 85a. At the depicted incident in time, the reflected image from 89 is incident upon the 67 portion of 85a which modulates the projected light to be a successive projected image quarter 91a which is incident upon the second quarter 95 of the diffuse surface.

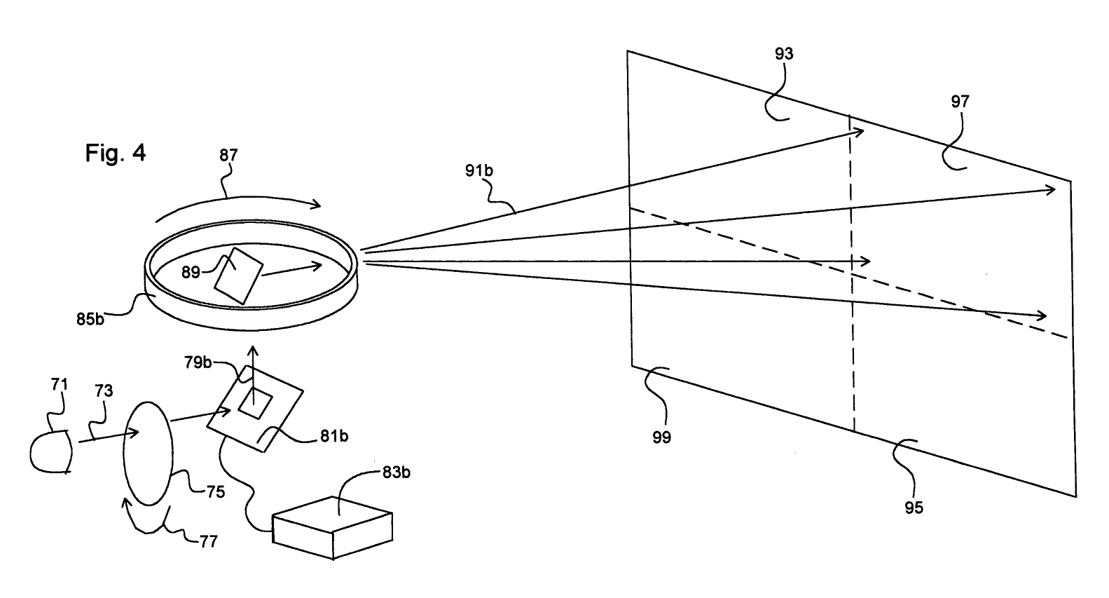

FIG. 4 depicts the projection system of FIG. 2 projecting the pixels of a DLP onto a third quadrant of a diffuse screen. In a second subsequent time and due to the 87 rotation, a rotating directing optic in second successive orientation 85b is now in position to direct light to the third quadrant of the diffuse screen 97 producing the third tile of a four tile image. A second successive processor 83b presents the third quarter of the high resolution image from memory to a second successive DLP chip set 81b which in turn produces red, green, and blue portions of a second successive image 79b which are reflected off of the 89 before being incident upon the 85b. At the depicted incident in time, the reflected image from 89 is incident upon the 69 portion of 85b which modulates the projected light to be a second successive projected image quarter 91b which is incident upon the third quarter 97 of the diffuse surface.

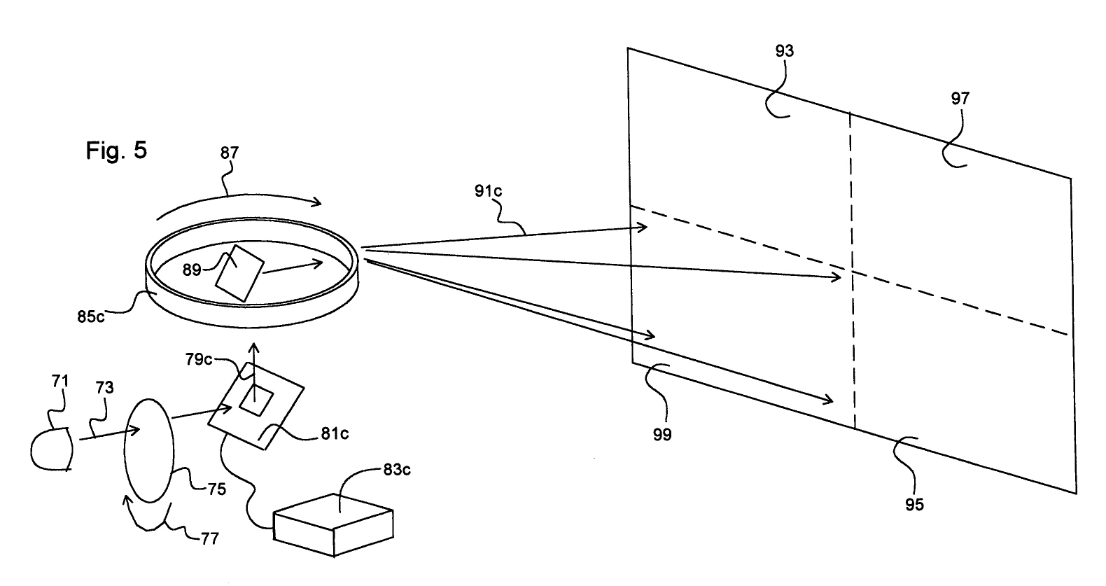

FIG. 5 depicts the projection system of FIG. 2 projecting the pixels of a DLP onto a fourth quadrant of a diffuse screen. In a third subsequent time and due to the 87 rotation, a rotating directing optic in third successive orientation 85c is now in position to direct light to the fourth quadrant of the diffuse screen 99 producing the fourth tile of a four tile image. A third successive processor 83c presents the third quarter of the high resolution image from memory to a third successive DLP chip set 81c which in turn produces red, green, and blue portions of a third successive image 79c which are reflected off of the 89 before being incident upon the 85c. At the depicted incident in time, the reflected image from 89 is incident upon the 71 portion of 85c which modulates the projected light to be a third successive projected image quarter 91c which is incident upon the third quarter 99 of the diffuse surface. Thus the 87 rotation has completed 360 degrees of rotation and an image has been projected upon the entire diffuse screen in four iterations of the DLP. This process is repeated at a 60 hertz rotation rate of the 87 such that high resolution video is projected. Thus four images from the DLP are tiled together on one display screen thereby multiplying the resolution of the DLP by four in the tiled image viewable on the display screen.

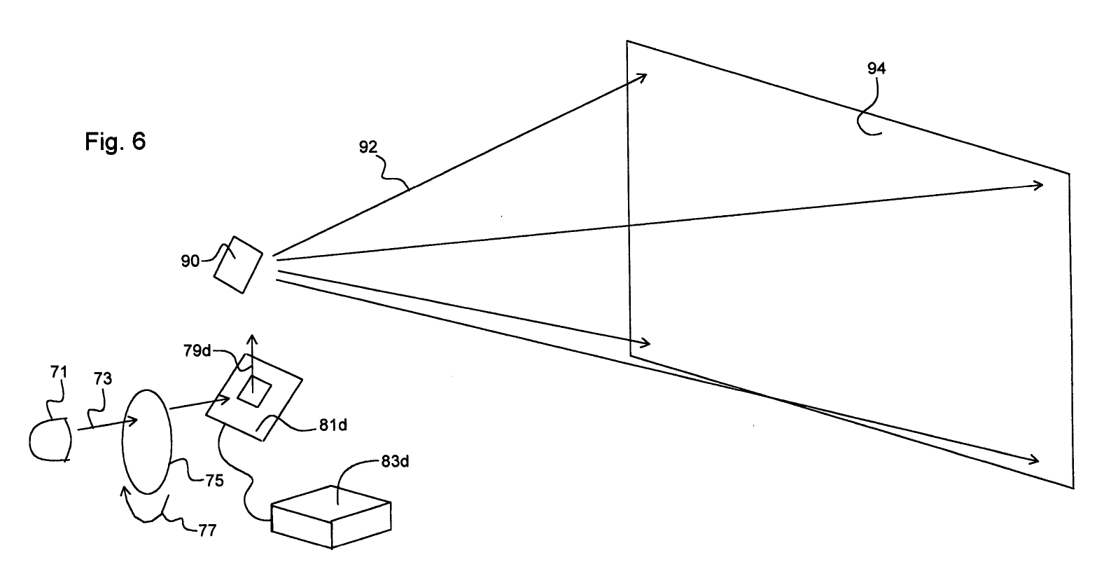

FIG. 6 depicts the projection system of FIG. 2 projecting the pixels of a DLP onto the entire surface of a diffuse screen. A processor of low resolution image 83d sends a signal to a DLP reflecting full image 81d to reflect a full image 79d which is reflected off a second shaping optic as a full projected image 92 to fill a full diffuse screen 94. Thus a different projection optic such as 90 and removal of the rotating steering elements cause the projector of FIG. 2 to be a full screen projector having the resolution of the DLP.

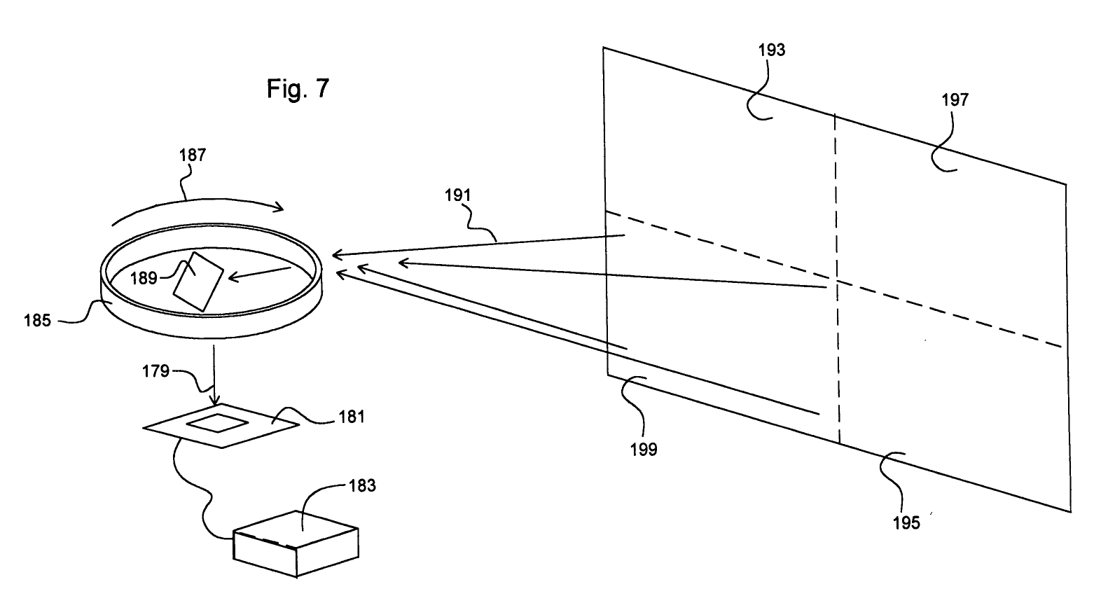

FIG. 7 depicts the high resolution video recording process using a rotating optic to multiply the resolution of a CCD. The optics and process taught in FIG. 2 can operate in reverse to comprise a high resolution camera. Light from a Pi steridian scene is incident upon a receiving steering optic 85d having the 87 rotation and refractive modulating segments as previously described. Included with the Pi steridians scene is a first quarter of scene to be captured 199 which includes a beam from scene 191 which is incident upon and passes through the 85d to be reflected by the 89 and directed as part of a focused quarter image 179 and ultimately incident upon a 1024×768 pixel resolution CCD. The CCD converts the 79 to an electric signal which is processed and recorded by a CPU with signal recorder 183 and stored in a memory comprised also within the 183. In subsequent iterations similar to those descried under FIGS. 1 through 6, the elements of FIG. 7 record three additional sections of the scene including subsequent section 193, second subsequent section 195, and third subsequent section 197. Thus an image having four times the resolution of the CCD is recorded for later playback. This completes a single 360 degrees of rotation 87 and an image has been recorded from a portion of the screen with four times the number of pixels on the CCD. This process is repeated at a 60 hertz rotation rate of the 87 such that high resolution video is recorded. High speed CCDs that can be used as 181 are well known in the prior art.

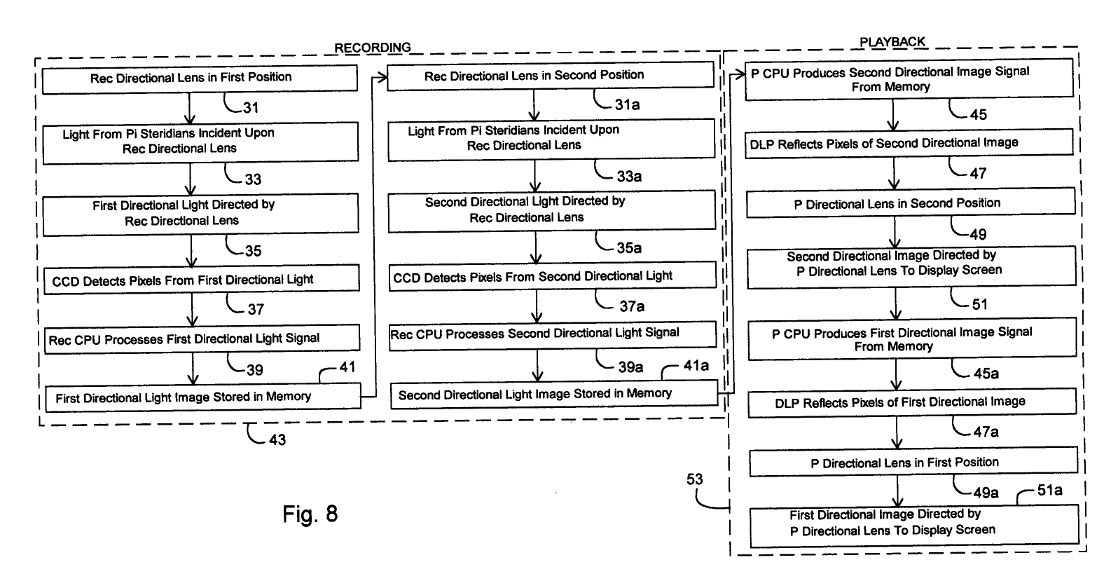

FIG. 8 illustrates the process for recording and projecting high resolution images of the first embodiment of the present invention. As descried in FIG. 7, a recording directional lens is in a first position 31. A light from a Pi steridians scene is incident upon the recording directional lens 33. A first directional portion of the incident light is directed by recording directional lens 35. The CCD detects pixels from first directional light 37. A recording CPU processes first directional light signal from the CCD 39. A first directional light image is stored in memory 43. Subsequently, the recording directional lens is in a second position 31a. The light from a Pi steridians scene is incident upon the recording directional lens 33a. A second directional portion of the incident light is directed by recording directional lens 35a. The CCD detects pixels from second directional light 37a. The recording CPU processes second directional light signal from the CCD 39a. A second directional light image is stored in memory 43. Similar steps are repeated in rapid iterations for four different parts of the scene to be recorded at a rate of 60 hertz. High speed cameras suitable for recording at high frame rates are know in the art and suitable for use with the directing optic to record scenes as described. A high resolution image recording process 43 consists of iterative cycles.

Once the high resolution scene is recorded, it is played back according to FIGS. 1 through 6. A Projection CPU produces a second directional image signal from memory 45. A DLP receives the signal from the CPU via an intervening buffer and reflects pixels from second directional image 47. A projector directional lens is in second orientation 49. A second directional image from the DLP passes through the directing lens to be incident upon a second predetermined portion of diffuse display screen 51. A Projection CPU produces a first directional image signal from memory 45a. A DLP receives the signal from the CPU and reflects pixels from first directional image 47a. A projector directional lens is in a first orientation 49a. A first directional image from the DLP passes through the directing lens to be incident upon a first predetermined portion of diffuse display screen 51a. A high resolution image display process 53 consists of iterative cycles. In addition to high resolution recorded images, media such as computer games and computer generated graphics can be displayed at very high resolution to conform with the pixel architecture described herein.

### Second Embodiment

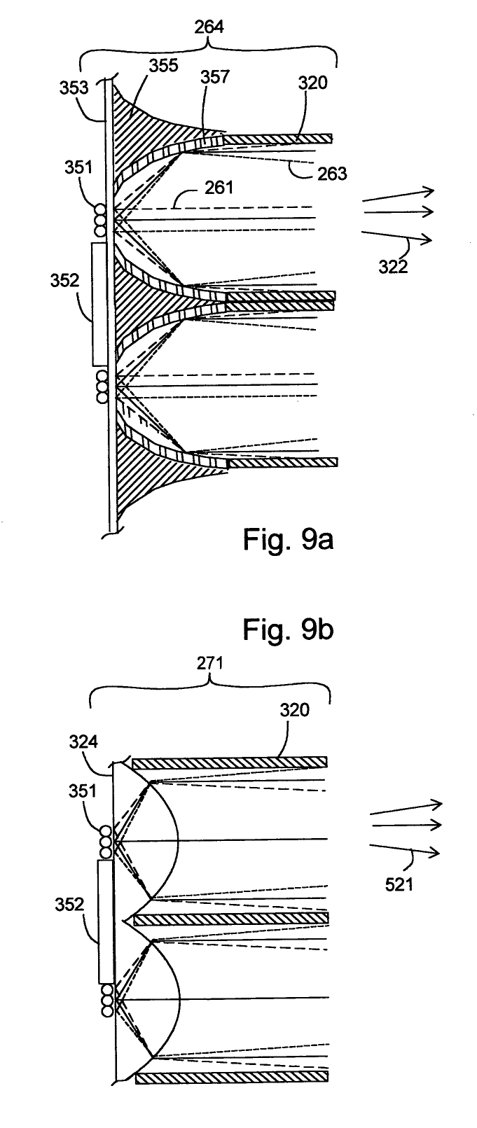

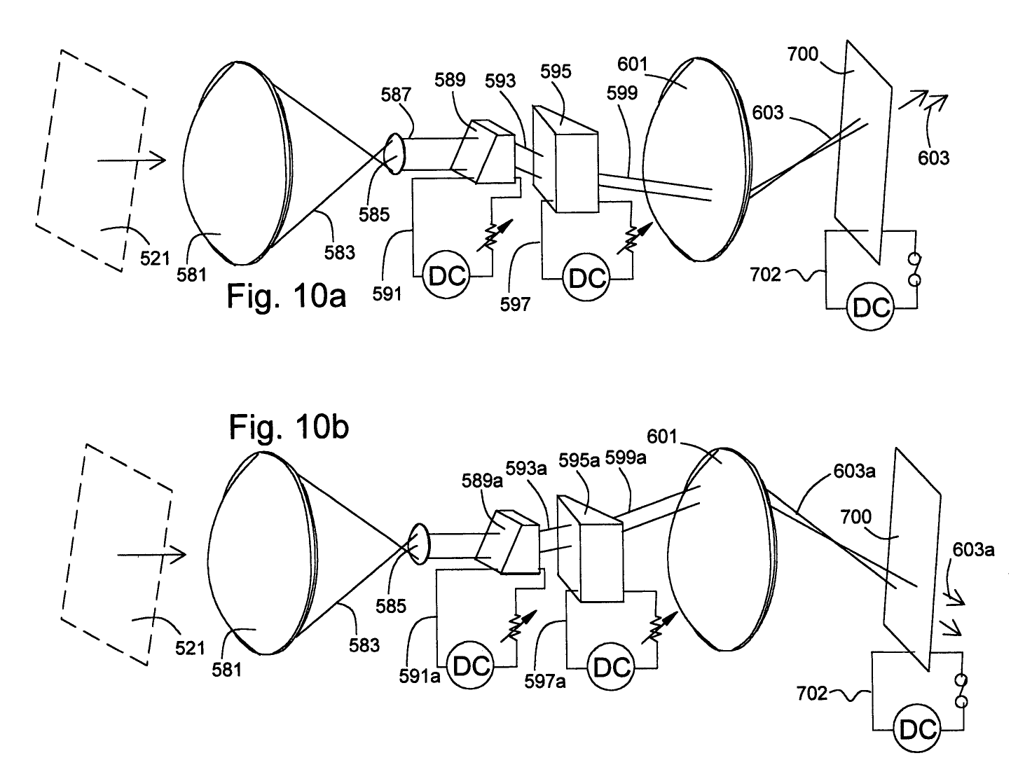

FIG. 9a illustrates a first pixel collimating architecture which was previously disclosed in a patent application by the present application. It comprises a first method of producing collimated pixels. In practice, arrays of similar structures can be used to create a collimated image for steering purposes described in FIG. 10a through 15. A first pixel 351 comprises separate red, green, and blue phosphors which are deposited on a glass substrate 353 as part of a CRT with many thousands of similar elements in array. An absorptive mask 352 is also deposited upon the 353 to absorb off axis light. An on axis light 261 is produced by the phosphors when they are illuminated as part of an image. Additionally, a reflective surface of predetermined curvature 357 is deposited upon a substrate 355 such that some off axis light from the 351 is reflected to become on axis light 263. An alternate efficient collimated pixel light 322 is thus produced for subsequent steering as an alternative to an efficient collimated pixel light 521 described in FIG. 9b. The 322 being produced by an alternate collimating pixel architecture 264.

FIG. 9b illustrates a second pixel collimating architecture. A pixel collimating architecture 271 consists of the 351 phosphors deposited upon a lens array substrate including CRT lens 324 the radius of 324 being half the focal length such that light produce by 351 as part of an image is efficiently collimated and off axis light is absorbed by an absorbing matrix 320. Thus the collimated pixel 521 is efficiently produced which contains individually controlled excitable phosphors each being a constituent of an array of similar pixels to produce a collimated image stream from a CRT display. This architecture for efficiently producing steerable pixels and images was disclosed in previous patent applications by the present applicant.

FIG. 10a discloses a collimated pixel LC steering method of producing multiple program and auto stereoscopic viewing zones in a first steering state. The art of steering pixels at the sub image level or the pixel level has been previously disclosed in patent applications by the present applicant referenced in the beginning of this document and incorporated herein by reference. The 521 pixel from FIG. 9b is incident upon a converging optic 581 to form convergent pixel 583 which is incident jupon a collimating optic 585 to produce compressed collimated pixel 587 which is incident upon a first vertical steering LC 589 which steers the pixel to become a first vertical steered pixel in response to an electric current applied by a first vertical control circuit 591. The 593 then being incident upon a horizontally steering LC 595 which produces horizontally steered pixel 599 in response to an electric field controlled by a first horizontal control circuit 597. The 599 then being incident upon an off axis angle magnifying lens 601 to produce a pixel on final trajectory 603 which is presented to user space as part of an auto-stereoscopic image, or as one of a plurality of programs that are concurrently displayed by the image steering display, or as part of a 2D image having the same resolution as the originating CRT pixel generator incorporating the pixels generation architecture of FIG. 9b. A user in a first observation position sees the 603 pixel representative of a first image stream or 3D perspective. Note that prior to diverging into user space, the 603 pixel passes through a PDLC sheet in transmissive state 700 which is aligned to be transparent in response to an electric field produce by an on circuit 702. It is noteworthy that the 589 also incorporates a polarizing filter to ensure that light passing beyond is in the same orientation as the LC elements.

FIG. 10b discloses a collimated pixel LC steering method of producing multiple program and auto stereoscopic viewing zones in a second steering state. The elements are those of 10a except a vertical steering LC in second state 589a produces a second vertically steered pixel trajectory 593a in response to a vertical steering control circuit in second state 591a. Also a horizontal steering LC in second state 595a causes the 593a to become second horizontally steered pixel 599a which is incident upon a different area of the 601 than was the 599 and is thus directed by the 601 to become a second pixel steered into user space 603a. After passing though the 700, the 603a is viewed by a second viewer as a pixel with resolution the size of 601 which is the same as the resolution of the 521 and underling CRT. The second user sees a different pixel emitted from the 601 than did the first user who saw the 603 the 603a being a part of a second perspective of an auto stereoscopic 3D video or a second program. Thus both users see a full resolution pixel from 601 yet each sees a different pixel. Each viewer similarly observes many thousands of pixels on the same display that can represent completely different images to each respective viewer or different perspectives dependent upon each respective viewer's position of the same 3-D auto-stereoscopic image. The achievement of auto stereoscopic 3D image streams and displaying of multiple programs concurrently using pixel steering of FIG. 10a and 10b has been described in prior applications of the present applicant which have been referenced herein.

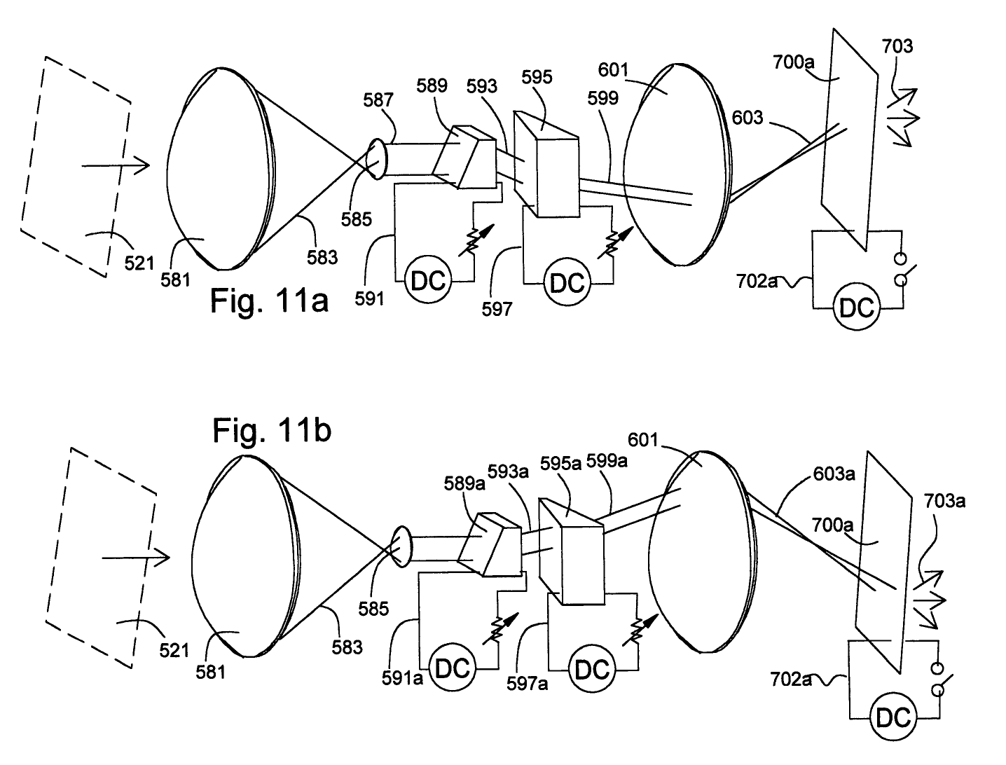

FIG. 11a depicts the art of FIG. 10a used for creating a first high resolution pixel. The elements in 11a are identical to those of 1a except that a PDLC in second state 700a has been switched by a control circuit in off state 702a. This has caused the PDLC to become translucent in FIG. 11a whereas it was transparent in FIG. 10a. Thus the steered 603 pixel no, longer passes through the PDLC uninterrupted to the first user but is instead scattered by the PDLC to become a first higher resolution pixel 703 viewable by both the first user and the second user.

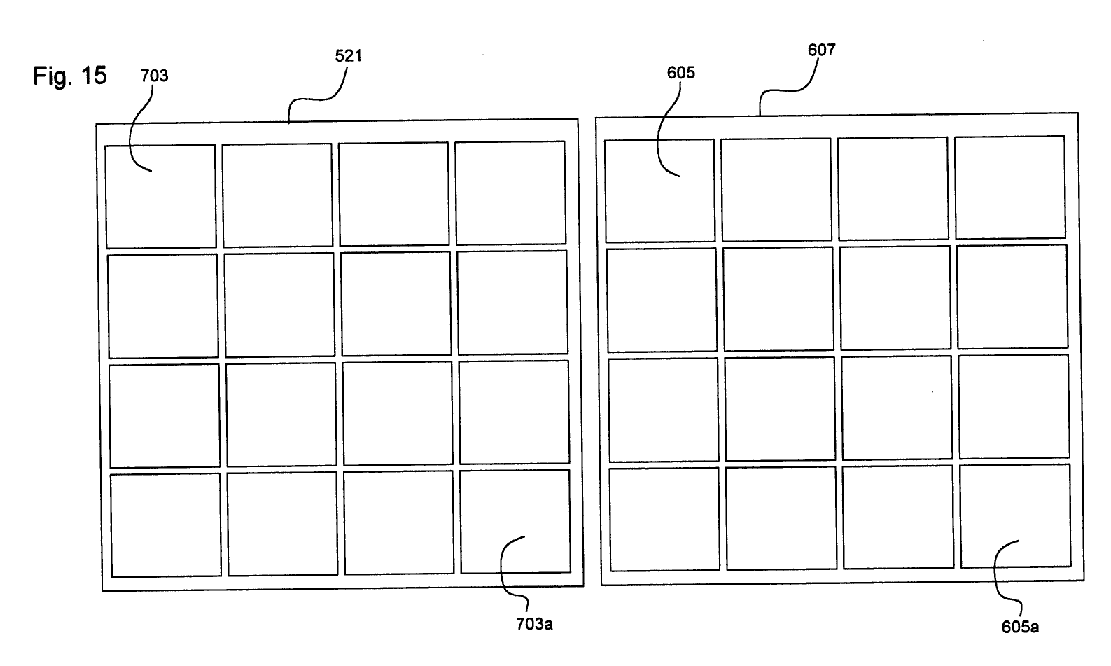

FIG. 11b depicts the art of FIG. 10b used for creating a second high resolution pixel. The elements in 11b are identical to those of 10b except that the PDLC in second state 700a has been switched by the control circuit in off state 702a. This has caused the PDLC to become translucent in FIG. 11b whereas it was transparent in FIG. 10b. Thus the steered 603a pixel no, longer passes through the PDLC uninterrupted to the second user but is instead scattered by the PDLC to become a second higher resolution pixel 703a viewable by both the first user and the second user. Thus FIGS. 11a and 11b illustrate that instead of seeing one pixel with the resolution of 603, both users see two pixels with twice the resolution of 603. Also the 603 pixel has the same resolution as the 521 pixel which is equal to the resolution of the CRT pixel generator. Many thousands of pixels in array are similarly displayed to produce a high resolution image viewable by both viewers which has higher resolution that the underlying CRT pixel generator. FIG. 15 compares the resolution of the CRT to the resolution of steering pixels in conjunction with any diffuse surface such as a PDLC in a translucent state. Using the pixel steering method described in FIGS. 11a and 11b, a wide range of resolutions can be displayed using the same elements with no need to change any elements.

### Third Embodiment

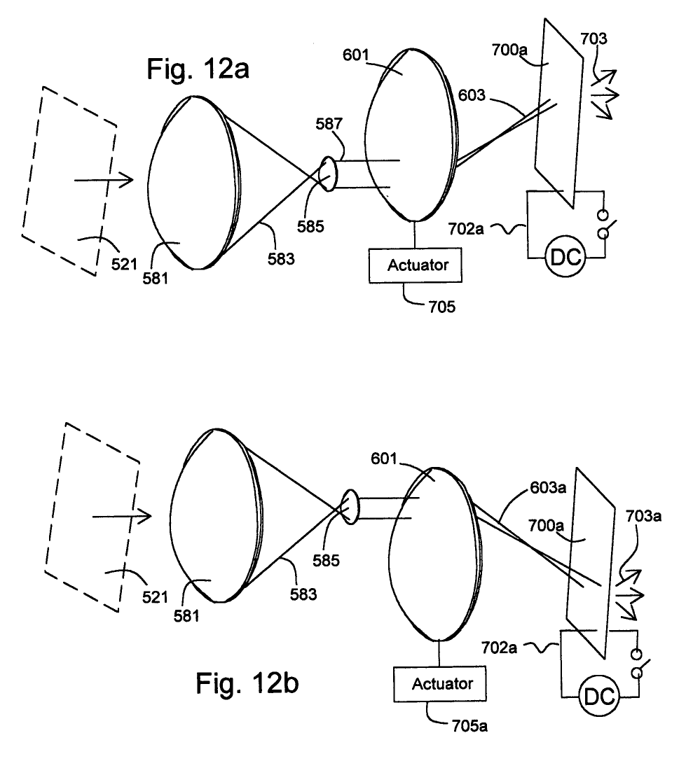

FIG. 12a depicts the high resolution pixel generation of 11a with an actuation steering method replacing the LC steering method generating a first high resolution pixel. All elements in the illustration operate identically to those in 11a except the 601 is actuated by a lens array actuator 705. The 705 actuates the 601 together with a sheet of thousands of lenses in array with and identical to 601. Many means are known for controllably actuating the 601 as part of an array through a range of positions such that over the course of each actuation cycle, the 587 beam will be incident upon a wide range of positions of the 601 and thus be steered by the 601 to be incident on the 700a over a wide range of positions and thereby forming a number of pixels conforming to the resolution of the image file to be displayed. The actuation of the lens array including 601 occurs at 60 hertz. In its depicted position, the 601 causes the 587 to be steered to become the 703 higher resolution pixel discussed in FIG. 11a.

FIG. 12b depicts the art of FIG. 12a generating the second high resolution pixel of FIG. 11b. In a subsequent part of the actuation cycle, the 585 pixel beam is incident upon a different portion of 601 compared to FIG. 12a to become the second higher resolution pixel 703a.

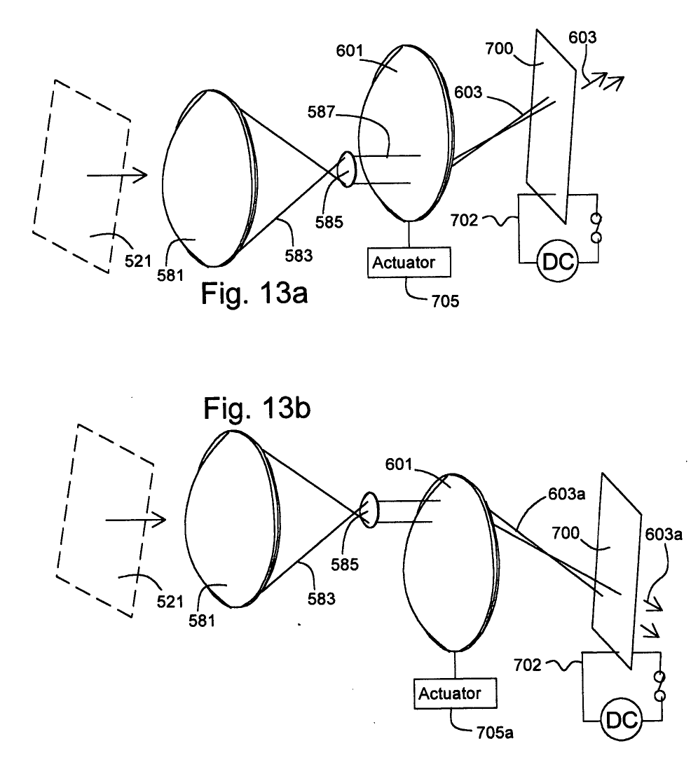

FIG. 13a depicts the art of FIG. 12a creating a pixel directed to a first viewing zone. The resultant pixel viewable by only the first user as discussed in FIG. 10a and for the purposes of displaying auto stereoscopic 3-D images or completely separate programs to respective users. This is because the 700 is in a transparent state.

FIG. 13b depicts the art of FIG. 12b creating a pixel directed to a second viewing zone. The resultant pixel viewable by only the second user as discussed in FIG. 10b and for the purposes of displaying auto stereoscopic 3-D images or completely separate programs to respective users.

Thus the art of FIGS. 10a through 13b can be used to reliably produce a wide range of high resolution images on the fly corresponding the of the image file to be displayed and based upon a lower resolution CRT with low incremental cost. The same display can produce auto stereoscopic 3D images viewable by multiple concurrent viewers at the resolution of the CRT pixel generator. Similarly, the same display can enable multiple users to concurrently watch completely different programs on the same display each full screen and at the resolution of the underlying CRT pixel generator.

FIG. 14 depicts a small portion of an array of pixel level optics similar to the individual optics depicted in FIG. 12a. A Pixel diverging lens array 611 includes the 581 lens and many thousands of similar lenses in array. A compressed collimating lens array 613 includes the 585 and thousands of similar lenses in array. A directing lens array 619 includes the 601 and many thousands of similar lenses which are actuated in array by the 705. The PDLC 700 can be switched between a transparent state to enable specific pixels to be directed to specific portions of user space enabling 3-D auto Stereoscopic viewing and multiple program viewing. Alternately, the PDLC 700 can be switched to a translucent state to provide high resolution images to multiple users at relatively low cost. The resolution of such images can be varied on the fly according to the resolution of the image file to be displayed, thus enabling this display to provide a functionality to cost benefit ratio exceeding what has been anticipated by others heretofore.

FIG. 15 illustrates the resolution enhancement of a low resolution CRT compared to the high resolution pixels created by steering the CRT pixels. When displayed on the translucent PDLC, the 703 pixel is one pixel in a high resolution display while the 703a pixel is a second pixel in a high resolution display. The 521 pixel from the CRT had a much lower resolution than the combination of pixels it produces using the present art including the 703, 703a, and all of the other pixels over which the 521 is superimposed for illustrative purposes. An adjacent pixel 607 is similarly produced by the lower resolution CRT and is steered to produce a first high resolution adjacent pixel 605 and a second high resolution adjacent pixel 605a. Many thousands of pixels are similarly produced on the CRT and subdivided by the art of the present invention in the higher resolution application. As an example of different levels of resolution supported by the system, to present a image with the resolution of 601, the 703 pixel and the 703a pixel together with the pixels in between can receive the exact same light. They thus act as a single pixel. Similarly, half of the pixels can operate as on pixel or a quarter of the pixels, etc. depending upon the resolution of the media to be displayed. Thus the resolution is adjustable on the fly without out changing any components of the system.

Operation of the Invention

Operation of the invention has been discussed under the above heading and is not repeated here to avoid redundancy.

### CONCLUSION, RAMIFICATIONS, AND SCOPE

Thus the reader will see that the Processes and Apparatuses for Efficient Multiple Program and 3D Display of this invention provides a novel unanticipated, highly functional and reliable means for producing multiple functionalities and resolutions in a single display. In a single display, high resolution media can be displayed, media of lower resolution can be displayed, auto stereoscopic 3D media can be displayed, and multiple programs streams can be displayed all on the same display.

While the above description describes many specifications, these should not be construed as limitations on the scope of the invention, but rather as an exemplification of a preferred embodiment thereof. Many other variations are possible.

Intervening optics can be added to optimize performance.

The 619 element including 585 can be eliminated from FIGS. 10a through 14 without diminishing the performance of high resolution aspects of the depicted displays. In this case the 601 would optimally be positioned and actuated approximately in the focal plane of 581. Also if the 613 is omitted, some advantages could be derived by actuating the 619 closer to or further from the 611 to achieve different levels of resolution. For maximum resolution, the 601 will be actuated around in patterns within the focal plane of 581.

Interchangeable optics can be added to be interchangeable in real time to enhance performance.

The optical structure of FIG. 1 can be replaced by other optical elements including refraction, reflection, and diffraction for example to produce similar results. A rotating mirror or a liquid crystal variable beam steering device are examples of equivalents of the FIG. 1 art and are anticipated herein.

The DLP described in FIG. 2 can be replaced by another image generating means, a LCoS being an example of alternate micro image generator.

The CRT pixel generator of FIGS. 9a and 9b can be replaced by another pixel generation means some examples being an LCD, an FED, or a DLP. Also, the light collimating structures in FIGS. 9a and 9b can be incorporated into the pixel generator such as in an LCD display which by its very nature is suited to generate collimated light.

While the resolution produced by the system of FIG. 2 is four times the resolution of the DLP pixel generator the art taught herein can produce greater resolution or lesser resolution.

The shaping mirror of FIG. 2 can be replaced by a flat mirror in which case more traditional projection optics can be utilized before the light is incident upon the rotating refracting optic 85 or after passing through 85. Also the DLP chip can be put at the center of the rotating optic and in cooperation with a transmissive optic can replace the 89 mirror altogether.

Many types of video monitors are well known and can be used with the method and elements described herein. For example, many techniques for projecting images are well known and could be used by one skilled in the art to physically segment multiple video streams according to the present invention. Many optical elements and combinations thereof are possible. Many optical arrangements of intervening optics have been described herein and others are possible using that which is taught herein. Many reflector configurations are possible. The variable Fresnel arrays described by the present inventor in U.S. Pat. No. 6,552,860 and other patents may be used as beam steerers in place of LCs and actuation of elements and performing substantially the same function. In addition to a DLP based projector, high speed projection using a three CRT system is also possible as are other projection techniques. Many solid state beam steering or deflecting techniques are known in the prior art. It should be understood that the term “display” and/or “screen” refers to a screen for receiving a light projection which is then viewed by an observer for the purpose of seeing a video monitor, television screen, a computer display, a video game screen, or device which substantially provides images to a user.

The prior related patent applications of the present applicant which are cross referenced herein also contain relevant information which is incorporated herein by reference but not repeated to avoid redundancy.

What is claimed:

1. A process for displaying high resolution images comprising the steps of:
providing a pixel generation means capable of generating a first number of pixels,
providing a stream of complete image frames wherein each frame comprises a greater number of pixels than said pixel generation means,
providing a modulation means for modulating the direction of pixels generated by said pixel generation means,
providing a display screen,
wherein a first portion of the said image frames are modulated by said modulation means to be incident upon a first portion of said display screen, and wherein a second portion of said image frames are modulated by said modulation means to be incident upon a second portion of said display screen, and whereby the first portion of said image frames and the second portion of said image frame together from a coherent image.

2. The process of claim 1 wherein said image frames are first broken into smaller sections of frames before being modulated to be incident upon a portion of said display screen.

3. A means for displaying a high resolution image comprising a means for scanning a pixel onto a diffuse surface.
